(19) United States
(12) Patent Application Publication
(10) Pub. No.: US 2009/0277091 A1
(43) Pub. Date: Nov. 12, 2009

(54) DOOR COMPRISING OBSTACLE-DETECTION MEANS WHICH ARE EQUIPPED WITH A CONNECTOR THAT IS FORMED BY TWO DETACHABLE PARTS

(75) Inventor: Bernard Kraeutler, Dunieres (FR)

Correspondence Address: CANTOR COLBURN, LLP, 20 Church Street, 22nd Floor, Hartford, CT, 06103, US

(73) Assignee: NERGECO, DUNIERES (FR)

(21) Appl. No.: 11/914,988

(22) PCT Filed: May 22, 2006
(86) PCT No.: PCT/FR06/01160

§ 371 Date: Nov. 20, 2007

(30) Foreign Application Priority Data
May 23, 2005 (FR) 0505152

(51) Int. Cl. E05F 15/10

(52) U.S. Cl. 49/28; 49/26

(57) ABSTRACT

The invention relates to a door comprising a frame and an apron (4) which can be moved by drive means between a closed position and an open position. The apron comprises obstacle-detection means which are connected by a cable (20) to a device for controlling the drive means. A first end (21) of the cable is associated with the. apron, while the second end (22) thereof is associated with the frame. The first and/or second end(s) of the cable comprise(s) a connector (19,23) which is mounted to an area of the apron or the frame such that it can rotate around an axis (26, 34) that is perpendicular to said area and which can be separated into two reconnectable parts by means of pulling. In this way, it is possible to detect one end of the cable associated with the apron or the frame.

### TECHNICAL FIELD OF THE INVENTION

The invention relates to a door of the type with an apron that can be moved by electromechanical drive means between a closed position and an open position.

The invention relates more particularly to flexible apron doors of e.g. folding or wind-up type designed to obstruct or open an opening formed in a wall separating two areas.

### BRIEF DISCUSSION OF RELATED ART

In these applications, the speeds at which the apron is driven for opening or closing are high. It is therefore necessary to provide safety systems associated with the door, notably to prevent injury or damage in the event of an accidental collision between the apron and a person or object.

For this purpose, in a known embodiment, the apron comprises obstacle-detection means connected to the control device of the electromechanical drive means. Thus for example, when the apron hits an obstacle during its closing movement, a signal is sent to the control device which can then act on the electromechanical drive means to stop the closing movement and possibly move the apron back in the opening direction.

The link between the obstacle-detection means and the control device may be a wire. If so, the cable employed is connected at a first end to a moving structure (the apron) and at a second end to a fixed structure (the control device or to an intermediate point on the wall to which the door is fixed).

Consequently, every time the apron is opened and closed, the cable is itself moved back and forth, at high speed. At its ends, the cable is particularly stressed and has to twist in order to follow the movement of the apron. As a result, the cable is severely fatigued and therefore at risk of breaking, at which point the safety of the door is no longer assured. This fatigue phenomenon is made the more acute by the fact that the apron is operated a very large number of times in a day.

Moreover, a moving person or object, such as a goods handling truck, may become caught in the cable and pull it at least partly free from the door. This risk is increased if the cable is already weakened as explained above. Once again, the consequence would be the loss of the door's safety system.

### BRIEF SUMMARY OF THE INVENTION

The invention improves the connection between the obstacle-detection means and the control device by providing a door that has a wire link which is reliable, robust and safe, and is thus able to meet the new safety standards.

For this purpose, the invention relates to a door comprising a frame defining an opening. The frame is designed to be fixed to a wall, said frame defining an opening and comprising two essentially vertical lateral jambs. The apron can be moved by electromechanical drive means mounted on the frame between a closed position in which the apron obstructs the opening, and an open position in which the opening is unobstructed; the apron comprising obstacle-detection means connected by a wire link to a device which controls the electromechanical drive means, and the wire link comprising a cable whose first end is connected to the apron and whose second end is connected to the frame.

The door is more particularly characterized in that it comprises at least one connector connecting the first end of the cable to the apron or the second end of the cable to the frame, said connector being mounted on either a region of the apron or on a region of the frame, in such a way that it is able to rotate about an axis approximately perpendicular to said region and being separable, when pulled, into two reconnectable parts, in such a way as to detach the end of the cable from either the apron or the frame, respectively.

The concept of the invention is thus to provide the cable with a connector which orients itself automatically to suit the position of the apron, in such a way that the cable is in the most direct possible position between the apron and the frame. Since the pivoting is now confined to the connector, the cable is not subjected to twisting. The service life of the cable is thus increased and, since the risk of breakage is reduced, the safety of the door is improved. Furthermore, if a person or machine catches against the cable, then above a certain traction force, the cable will simply “pop out” of the apron (or frame) and will not be ripped out. It can therefore be put back in the operating position very quickly and easily by hand without the use of any special tools.

The door may comprise a single connector connecting the first end of the cable to the apron, while the second end of the cable is directly connected to the frame, without an intermediate connector, or a single connector connecting the second end of the cable to the frame, while the first end of the cable is directly connected to the apron, without an intermediate connector.

In one embodiment of the door according to the invention, the door comprises a first connector connecting the first end of the cable to the apron and a second connector connecting the second end of the cable to the frame, said connectors being essentially identical.

Each end of the cable can thus pivot relative to the door: twisting, and therefore cable wear, are thus minimized.

To minimize the length of cable necessary for proper operation of the door and safety system, the second connector may be mounted on a jamb, approximately halfway up said jamb, while the first connector is mounted on the apron close to the lateral edge of the apron adjacent to said jamb.

In a variant, the door comprises an approximately horizontal upper hood beneath which the apron can be housed in the open position, and the second end of the cable is connected to said hood and the first end of the cable is connected to the apron by a connector so arranged that the cable is approximately vertical when the apron is closed, said connector being designed not to interfere with the positioning of the apron beneath the hood when open.

The connection between the connector and the apron, or between it and the frame, may be a ball joint.

This connection, by giving greater freedom of movement to the connector, further reduces the wear on the cable.

In one embodiment the connector comprises a ring mounted on the apron, or on the frame, and an elbow piece having a first arm mounted approximately coaxially relative to the ring in such a way that it can rotate about the axis of the ring, and having a second arm which receives detachably a pin attached to the end of the cable.

Additionally, the first arm of the elbow piece may be fixed to a cylindrical bush mounted approximately coaxially in the ring, said cylindrical bush being able to pivot about its axis.

In one advantageous provision, the cable is in the form of an elastically extensible helix.

This makes the cable compact. It also does not dangle and does not pull too much on either the apron or the frame, wherever the apron is between the open and closed positions.

In the case of a high-speed door, the apron is formed by a flexible plastic sheet or an assembly of flexible plastic sheets.

The door may also include means for immobilizing the apron in a predetermined position, said means being coupled to the electromechanical drive means and controlled by the separation of the connector into its two reconnectable parts. Separation of the two parts of the connector therefore leads to the apron either stopping in the position in which it happens to be at the moment, or moving to a stop position which is selected to suit the application (for example the open position).

### BRIEF DESCRIPTION OF THE DRAWINGS

To explain the invention clearly, it will now be described again with reference to the attached figures which show, by way of non-restricted example, one possible embodiment of the door.

FIG. 1 is a schematic front view of a door according to the invention, showing the frame and the apron in the closed position;

FIG. 2 is a partial enlarged perspective view of the lower part of the door, apron closed, showing the wire link and the connectors, one connector on one of the jambs of the frame and the other on the apron;

FIG. 3 is a partial enlarged perspective view of the upper part of the door, apron open, showing the wire link and the same connectors;

FIG. 4 is an enlarged view of the detail marked IV in FIG. 2;

FIG. 5 is an enlarged view of the detail marked V in FIG. 3;

FIG. 6 is a side view of the apron, showing a protective shell around the connector; and

FIG. 7 is a front view of the apron shown in FIG. 6 equipped with the shell.

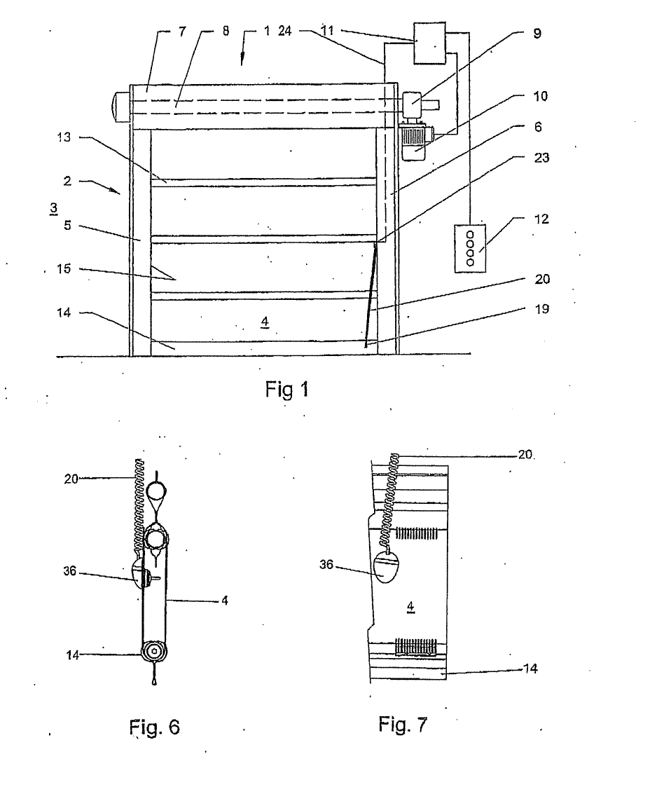

### DETAILED DESCRIPTION OF THE INVENTION

The door 1 comprises a frame 2 fixed to a wall 3 defining an opening, and a flexible apron 4 to close the opening.

The frame 2 has two vertical jambs 5, 6 and a horizontal upper crossmember 7 forming a hood containing a horizontal shaft 8 on which the apron 4 is wound and unwound to open or close the opening. The shaft 8 may be turned about its axis, via reducing gears 9, by an electric motor 10 controlled by an electronic control device 11. A manual control box 12 connected to the control device 11 may be provided on the wall 3 beside the door 1, and allows a user to open or close the opening.

The apron 4 is a flexible sheet made of a plastic, such as PVC, and includes horizontal reinforcing bars 13. The apron 4 also has a flexible deformable weighted sill bar 14, which contains obstacle-detection means (not shown). These obstacle-detection means may consist for example of an infrared beam which can be cut by a projecting part when the sill bar 14 is deformed as a result of an impact, or may consist of two slats which come into contact when struck by an obstacle and thus allow an electric current flow.

The apron 4 can be moved between a high position, in which it is completely wound onto the shaft 8 and the opening is completely unobstructed, and a low position in which it is completely unwound and the opening is obstructed. These movements of the apron 4 are performed at high speed, many times a day.

To facilitate these movements, the jambs 5, 6 comprise, on their inside face 15—that is, their face nearest the apron 4—two longitudinal ribs 16, 17 defining a track 18 between them in which the lateral edges of the apron 4 are guided when the apron 4 is moving.

A wire link connects the obstacle-detection means to the control device 11 so that, for example, when an obstacle is encountered when the apron 4 is on its way down, the motor 10 is tripped to stop the movement of the apron 4 or open it.

The wire link comprises in succession a conductor (not shown) connecting, inside the sill bar 14′ the obstacle-detection means to a first connector 19 mounted on the apron 4, an external cable 20 connected at a first end 21 to the first connector 19 and at a second end 22 to a second connector 23 mounted on the jamb 6, and a conductor 24 housed at least partly inside the jamb 6 to connect the second connector 23 to the control device 11.

The second connector 23 is mounted on a jamb (jamb 6 in this case) at a point about halfway up the jamb 6, while the first connector 19 is mounted on the lower part of the apron 4, on the sill bar 14, near the lateral edge of the apron 4 adjacent to the jamb 6. As a result, the distance between the two connectors 19, 23 does not exceed one half of the height of the apron 4, regardless of whether the apron is at the top or bottom. This limits the length of cable 20 required and also limits the deformation of the cable 20.

In addition, the second connector 23 is mounted on the inside face 15 of the jamb 6. The cable 20 is therefore situated in the immediate vicinity of the apron 4 and does not project from the door 1 beyond the thickness of the jambs 5, 6. This limits the risk of a person or object catching against the cable 20.

The cable 20 is in the form of an elastically extensible helix, like a telephone cable, whose length at rest (when the turns are closed up) is less than half the height of the jambs 5, 6. Hence, when the apron 4 is either open or closed, the cable 20 is slightly stretched and does not offer any dangling parts that could be easily caught.

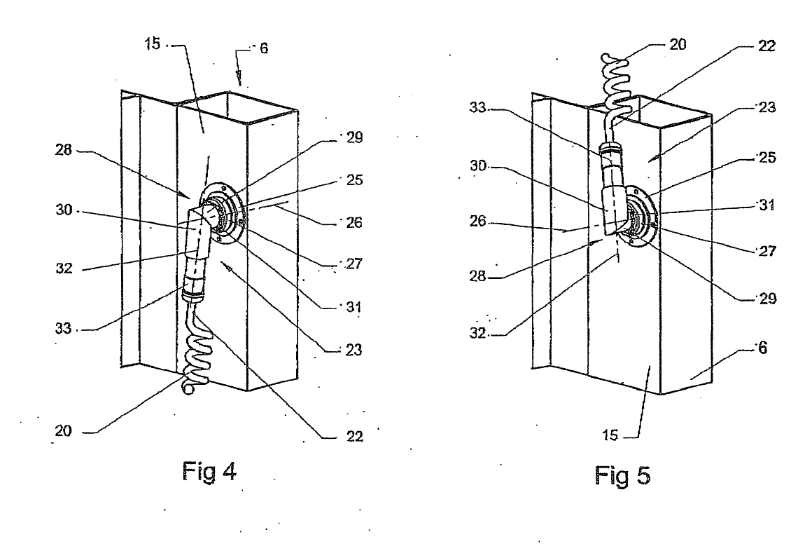

The connector 23 will now be described in more detail with reference to FIGS. 4 and 5.

The connector 23 comprises a ring 25 fixed, for example by screws, to the inside face 15 of the jamb 6 so that its axis 26 is perpendicular to the inside face 15. A cylindrical bush 27 is mounted in the orifice of the ring 25, essentially coaxially, so as to be able to pivot about its axis 26.

The connector 23 also includes an elbow piece 28 comprising first and second hollow cylindrical arms 29, 30 of identical cross section. The second arm 30 is perpendicular to the first arm 29 and longer. The first arm 29 comprises, at its end not connected to the second arm 30, a transverse square plate 31 fixed to the cylindrical bush 27 so that the axis of the first arm 29 coincides with the axis 26 of the ring 25. The axis 32 of the second arm 30 is thus parallel to the inside face 15 of the jamb 6.

Lastly, the connector 23 comprises a cylindrical pin 33 whose outside diameter is slightly less than the inside diameter of the second arm 30 of the elbow piece 28. One end of the pin 33 is attached to the second end 22 of the cable 20, while its opposite end is intended to be inserted like a male plug into the second arm 30 to make electrical contact with the conductor 24 via the elbow piece 28.

The pin 33 and the elbow piece 28 can be separated from each other by simply pulling on the pin 33, above a certain load. This can happen accidentally when a moving person or object catches against the cable 20 and pulls it. However, the cable 20 can be reconnected very easily to the conductor 24 by pushing the pin 33 back into the elbow piece 28.

The first connector 19 is identical to the second conductor 23, and is mounted as follows: the ring 25 is fixed to the apron 4 in such a way that its axis 34 is perpendicular to the plane of the apron 4; the axis of the first arm 29 of the elbow piece 28 coincides with the axis 34 of the ring 25; and the axis 35 of the second arm 30 is parallel to the plane of the apron 4. The pin 33 is on the one hand attached to the first end 21 of the cable 20 and on the other hand engaged, at its opposite end, in the second arm 30 of the elbow piece 28, thus making electrical contact with the conductor connected to the obstacle-detection means, via the elbow piece 28.

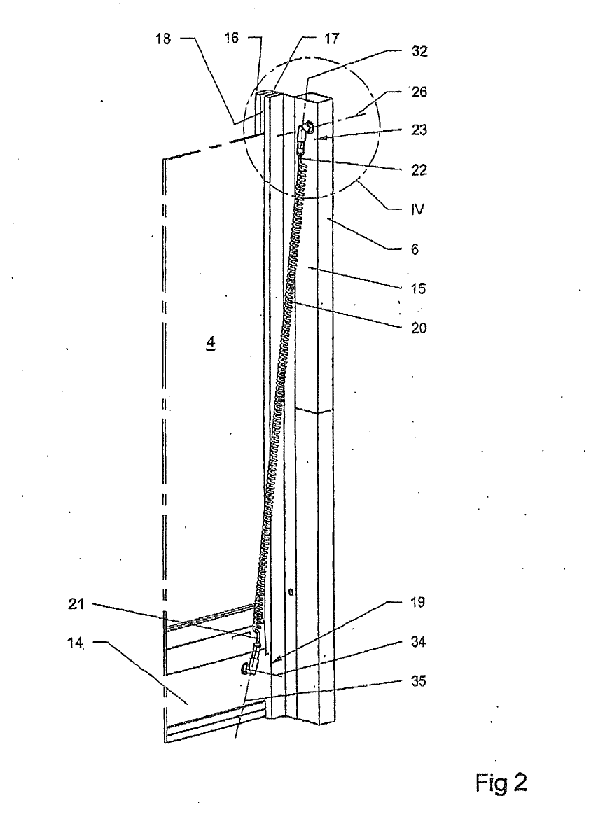

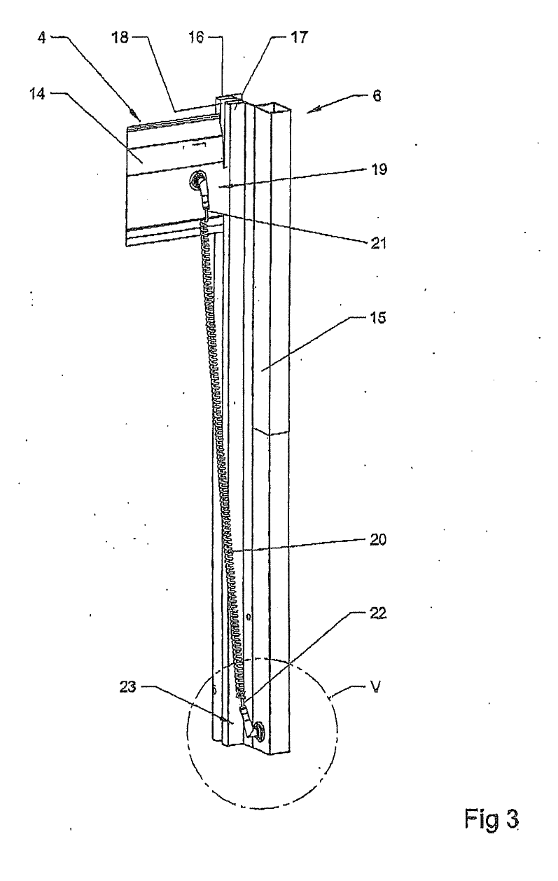

Because of the structure, the connectors 19, 23 can pivot about the axes 34, 26 of the rings 25. They thus orientate themselves automatically depending on the position of the apron 4:
when the apron 4 is in the low position (FIGS. 2 and 4), the first end 21 of the cable 20 is situated lower than the second end 22 and the cable 20 is at its most stretched. The second arm 30 of the first connector 19 points up and the second arm 30 of the second connector 23 points down, while the axes 35, 32 are approximately collinear and approximately coincide with the axis of the cable 20;
when the apron 4 is being moved toward its high position, the first end 21 of the cable 20 is moved translationally along an ascending vertical path. The first end 21 steadily approaches the second end 22 until their heights are the same, after which it moves steadily past it as the movement continues. During this movement the apparent length of the cable 20 decreases because of its elasticity, until the turns are in mutual contact. Then, when the distance between the connectors 19, 23 is less than the length at rest of the cable 20, one portion of the cable 20 begins to dangle. The length of this portion reaches its maximum when the two connectors 19, 23 are both of the same height, after which it reduces as the ascending movement continues, until finally vanishing. By the end of the movement the cable 20 is once again stretched. During this movement, also, the connectors 19, 23 pivot about the axes 34, 26, respectively, so as to follow the movement of the apron 4 and cable 20. When the cable is stretched and therefore straight, it forces the connectors 19, 23 to pivot until the axes 35, 32 are approximately collinear and approximately coincide with the axis of the cable 20;
and when the apron 4 is in the high position (FIGS. 3 and 5), the second end 22 of the cable 20 is situated lower than the first end 21 and the cable 20 is at its most stretched. The second arm 30 of the first connector 19 points down and the second arm 30 of the second connector 23 points up, the axes 35, 32 being approximately collinear and approximately coinciding with the axis of the cable 20.

A cable 20 tension maintaining system may be provided, e.g. a seatbelt-type winder or a tensioning system using a weight acting via a turn pulley (when the apron is open, the cable and its weight are at their lowest position inside the jamb, and when the apron is closed, the cable and its weight are at their highest position inside the jamb).

Additionally, as depicted in FIGS. 6 and 7, the door 1 may comprise a protective shell 36 mounted removably on the apron 4 around the first end 21 of the cable 20 and around the first connector 19, so as to form with the apron 4 an essentially hermetic enclosure. “Essentially hermetic” here means that the first connector 19 and the region of connection between the cable 20 and the apron 4 are protected from dust and trickling water.

For this purpose the shell 36 is rounded in shape and has a generally smooth outer surface. This shape allows water to run off when the door is exposed to the weather, and it also limits the risk of the shell 36 catching against anything, even in an impact.

Similarly, of course, a shell 36 may be provided for the second end 22 of the cable 20.

The invention thus represents a decisive improvement on the prior art by providing a door with a robust and durable safety system.

It goes without saying that the invention is not limited to the embodiment described above by way of example but that on the contrary it encompasses all alternative embodiments thereof.

1. A door comprising:
a frame designed to be fixed to a wall, said frame defining an opening and comprising two essentially vertical lateral jambs; and
an apron that can be moved by electromechanical drive means mounted on the frame between a closed position in which the apron obstructs the opening, and an open position in which the opening is unobstructed,
the apron comprising obstacle-detection means connected by a wire link to a device which controls the electromechanical drive means, and
the wire link comprising a cable whose first end is connected to the apron and whose second end is connected to the frame;
wherein said door being wherein comprises at least one connector connecting a first end of the cable to the apron or a second end of the cable to the frame, said connector being mounted on either a region of the apron or on a region of the frame, in such a way that it is able to rotate about an axis approximately perpendicular to said region and being separable, when pulled, into two reconnectable parts, in such a way as to detach the first or second end of the cable from either the apron or the frame, respectively.

2. The door as claimed in claim 1, wherein it comprises a single connector connecting the first end of the cable to the apron, while the second end of the cable is directly connected to the frame, without an intermediate connector.

3. The door as claimed in claim 1, wherein it comprises a single connector connecting the second end of the cable to the frame, while the first end of the cable is directly connected to the apron, without an intermediate connector.

4. The door as claimed in claim 1, wherein it comprises a first connector connecting the first end of the cable to the apron and a second connector connecting the second end of the cable to the frame, said connectors being essentially identical.

5. The door as claimed in claim 4, wherein the second connector is mounted on a jamb, approximately halfway up said jamb, while the first connector is mounted on the apron close to a lateral edge of the apron adjacent to said jamb.

6. The door as claimed in claim 1, wherein it comprises an approximately horizontal upper hood beneath which the apron can be housed in the open position, and the second end of the cable is connected to said hood and the first end of the cable is connected to the apron by a connector so arranged that the cable is approximately vertical when the apron is closed, said connector being designed not to interfere with positioning of the apron beneath the hood when open.

7. The door as claimed in claim 1, wherein the connection between the connector and the apron, or between it and the frame, is a ball joint.

8. The door as claimed in claim 1, wherein the connector comprises a ring mounted on the apron, or on the frame, and an elbow piece having a first arm mounted approximately coaxially relative to the ring in such a way that it can rotate about the axis of the ring, and having a second arm which receives detachably a pin attached to the end of the cable.

9. The door as claimed in claim 8, wherein the first arm of the elbow piece is fixed to a cylindrical bush mounted approximately coaxially in the ring, said cylindrical bush being able to pivot about its axis.

10. The door as claimed in claim 1, further comprising at least one protective shell attached removably either to the apron or to the frame, around the first end of the cable or around the second end, respectively, and around the potential associated connector, in such a way as to form with either the apron or the frame an essentially hermetic enclosure.

11. The door as claimed in claim 10, wherein the outer face of the shell is basically smooth.

12. The door as claimed in claim 1, wherein the cable is in the form of an elastically extensible helix.

13. The door as claimed in claim 1, wherein it includes a system for maintaining the tension of the cable.

14. The door as claimed in claim 1, wherein the apron is formed by a flexible plastic sheet or an assembly of flexible plastic sheets.

15. The door as claimed in claim 1, wherein it includes means for immobilizing the apron in a predetermined position, said means being coupled to the electromechanical drive means and controlled by the separation of the connector into its two reconnectable parts.
